(19) United States
(12) Patent Application Publication
(10) Pub. No.: US 2009/0056080 A1
(43) Pub. Date: Mar. 5, 2009

(54) APPARATUS FOR FORMING PARTICLES OF A TARGET SUBSTANCE

(75) Inventor: Olivier BOUTIN, Marseille (FR)

Correspondence Address: YOUNG & THOMPSON, 209 Madison Street, Suite 500, ALEXANDRIA, VA, 22314, US

(73) Assignee: UNIVERSITE PAUL CEZANNE AIX MARSEILLE III, AIX EN PROVENCE (FR)

(21) Appl. No.: 11/846,554

(22) Filed: Aug. 29, 2007

(51) Int. Cl. B01D 9/00

(52) U.S. Cl. 23/300; 422/105; 422/112; 422/245.1

(57) ABSTRACT

Reactor vessel for an apparatus for forming particles of a target substance, includes:
a first tube having an inlet end for receiving a supercritical antisolvent fluid and an outlet end for transmitting particles formed within the reactor vessel, and
a second tube, coaxial with the first tube and having an inlet end for receiving a solvent containing a solute of a target substance to be precipitated and an outlet end within the first tube for allowing contacting the supercritical antisolvent fluid with the solvent. The reactor vessel may be easily scaled up by connecting the outlet end of each first tube of a plurality of first tube/second tube pairs to a single container for receiving the formed particles.

### FIELD OF THE INVENTION

The present invention generally relates to the formation of particles and more particularly relates to the formation of particles by contacting a solvent containing a solute of a target substance and a supercritical antisolvent fluid.

### BACKGROUND OF THE INVENTION

In order to produce micro or nano particles, conventional methods such as milling or classical precipitation using organic solvents present important disadvantages. For instance, due to mechanical stress or high temperature, degradation of the products during the process may occur as well as organic solvents traces in the final product.

These drawbacks are particularly important in the process for controlling pharmaceutical molecules particles.

More appropriate methods using supercritical fluids have been developed for such purposes. The most commonly used supercritical fluid is carbon dioxide (CO₂), due to its advantages : low supercritical conditions (P_{c}=7.38 MPa and T_{c}=304 K) that are easily reached, a gaseous state at ambient conditions (easy separation at the end of the process), a high diffusivity (important property for the mass transfer during particle formation), a low viscosity as that of gases, a high density as that of liquids, and low viscosity.

A conventional method uses CO₂ as an antisolvent is the Supercritical AntiSolvent (SAS) method.

Typically, the SAS method at laboratory scale can be described as follows: in a reactor of medium volume (typically from 0.5 up to a few litres) a continuous flow of carbon dioxide in supercritical conditions (typically 8-15 MPa and 308-340 K) is introduced at the top of the reactor. The same flow rate of fluid exits at the bottom of the reactor in steady state conditions in order to maintain a constant pressure. The organic solvent, in which the solute to be precipated is solubilised, is introduced in a co-current mode in the supercritical medium through a capillary or a nozzle. The process of formation of a solid can be described as follows: a drop or an entity of the organic solvent exchanges matter with the supercritical carbon dioxide (CO₂ solubilisation into the entity and simultaneous evaporation of the solvent). As the concentration of CO₂ increases within the entity, the resulting supersaturation of the solute leads to its precipitation. The solid thus formed is recovered at the end of the experiment inside the reactor. A full description of this process can be found in G. Charbit et al., Methods of Particle Production, in P. York, U. B. Kompella, B. Shekunov (Eds.), Supercritical Fluid Technology for Drug Product Development, serie 138, 2004, Pages 159 et seq.

This conventional SAS process works well at laboratory scale, but it is not easy to derive therefrom a process to produce the quantities required for industrial production.

One solution suggested by R. Thiering et al. (in “Current issues relating to antisolvent micronisation techniques and their extension to industrial scales”, Journal of Supercritical Fluids, vol. 21, 2001, pp. 159-177) is to multiply the injection devices in the same reactor. They propose to scale up the process by using a large number of nozzles and the key parameters in this case are dimensionless groupings such as Reynolds, Weber and Ohnesorge, etc. By this way, the hydrodynamics jet is controlled and the scale up is just a matter of modular design. Badens et al.'s work [in “Laminar Jet Dispersion and Jet Atomization in Pressurized Carbon Dioxide”, Journal of Supercritical Fluids, vol. 36, 2005, pp. 81-90) can be useful in this case in order to maintain direct atomisation of the organic solvent, which is probably a key factor for a successful fine particle generation.

A similar solution was proposed by M. Perrut et al. (in “Supercritical Fluid Formulation : Process Choice and Scale-up”, Ind. Eng. Chem Res. vol. 42, 2003, pp. 6375-6383). They expose some major issues about the system. They indicate that it should be difficult to realise an atomisation system with several nozzles leading to a perfect fluid distribution. The major drawback should be the interaction between the resulting entities of the different injection devices leading to a coalescing and wide size distribution.

### BRIEF SUMMARY OF THE INVENTION

In view of the foregoing it is a primary objective of the invention to provide an apparatus able to produce particles in quantities required for industrial production and in which the particles have a small size distribution.

In accordance with these and other objectives, the present invention is directed to an apparatus for forming particles of a target substance comprising: a source of supercritical antisolvent fluid; a source of a solvent containing a solute of a target substance to be precipitated; a reactor vessel having a first inlet end connected to the source of supercritical antisolvent fluid, a second inlet end connected to the source of solvent, and an outlet end; a container connected to the outlet end of the reactor vessel for receiving the precipitated target substance; and control means to operate the apparatus wherein, said reactor vessel comprises a set of at least one tube pair, each tube pair comprising a first tube having a first end and a second end, and a second tube having a first end and a second end, the first and second tubes of each said tube pair being coaxial, the first inlet end of the reactor vessel being formed by the first end of all first tubes, the second inlet end of the reactor vessel being formed by the first end of all second tubes, the outlet end of the reactor vessel being formed by the second end of all first tubes, and the second end of each second tube being located closer to the first end of the corresponding second tube than to the second end of said corresponding first tube.

The simplest reactor vessel comprises a single one tube pair. It is thus very compact and simple. The advantage of this structure is that it is very easy to scale up the system by multiplying the number of tube pairs.

The target substance may be any substance which needs to be produced in particulate form. Examples include pharmaceuticals; pharmaceutical excipients such as carriers, dyestuffs, foodstuffs, coatings, agrochemicals; products of the use in ceramics, explosives or photographic industry, etc. The target substance may be organic or inorganic, monomeric or polymeric. It may in particular be a hydrophilic material such as a sugar, protein or enzyme.

The formed particles are generally in the micrometric range. They may be spherical or elongated depending on the requirement for their intended use and the process conditions.

The supercritical antisolvent fluid may be for instance carbon dioxide, nitrogen, nitrous oxide, sulphur hexafluoride, xenon, ethylene, chlorotrifluoromethane, ethane, trifluoromethane or a noble gas such as helium or neon, in an appropriate condition with respect to its critical temperature and pressure.

The solvent may be an organic solvent such as acetone, methylene chloride, ethanol, methanol or dimethylsulfoxide.

According to disclosed embodiments of the invention, the tube pairs are dimensioned and the control means is operated such that the supercritical anti-solvent fluid flows at a velocity of at least 1 mm/s within the first tube. The container is provided with a filter to retain the formed particles. The first tube of each tube pair has a length between 300 and 800 mm and an inner diameter between 2 and 20 mm. The second tube of each tube pair has a length between 60 and 150 mm and an inner diameter between 50 and 500 μm. The second end of the second tube of each tube pair is within the first tube at a distance of at least 100 mm from the first end of said first tube. The ratio between the length and the inner diameter of each tube is larger than 30, preferably larger than 50, and more preferably larger than 80.

The invention is also directed to a reactor vessel for an apparatus for forming particles of a target substance comprising a first tube having an inlet end intended, in operating conditions, to receive a supercritical antisolvent fluid and an outlet end intended, in operating conditions, to transmit particles formed within the reactor vessel, and a second tube, coaxial with the first tube and having an inlet end intended, in operating conditions, to receive a solvent containing a solute of a target substance to be precipitated and an outlet end within the first tube for allowing contacting the supercritical antisolvent fluid with the solvent.

According to disclosed embodiments of the invention, the reactor vessel comprises a plurality of first and second coaxial tubes, the second end of each first tube being mounted on one and the same plate support. The support plate forms the cover of a container for retaining the particles.

The invention is further directed to a method for forming particles of a target substance comprising (a) providing in a predetermined direction a flow of a supercritical antisolvent fluid, (b) providing in the same direction a flow of a solvent containing a solute of the target substance to be precipitated, wherein the two flows are coaxial and the supercritical antisolvent fluid has a velocity of at least 1 mm/s.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of present invention, and together with the description serve to explains the principles of the invention. In the drawings:

FIG. 1 is a schematic representation of an apparatus for forming particles according to an embodiment of the invention;

FIG. 2 represents a tube pair forming a reactor vessel or part of a reactor vessel for an apparatus for forming particles;

FIG. 3 is a SEM photography of run #8 of Example 1;

FIG. 4 is a SEM photography of run #14 of Example 1;

FIG. 5 is a SEM photography of run #7 of Example 2; and

FIG. 6a and 6b are a top view and a side view, respectively, of a reactor vessel comprising a plurality of tube pairs.

### DETAILED DESCRIPTION OF THE INVENTION

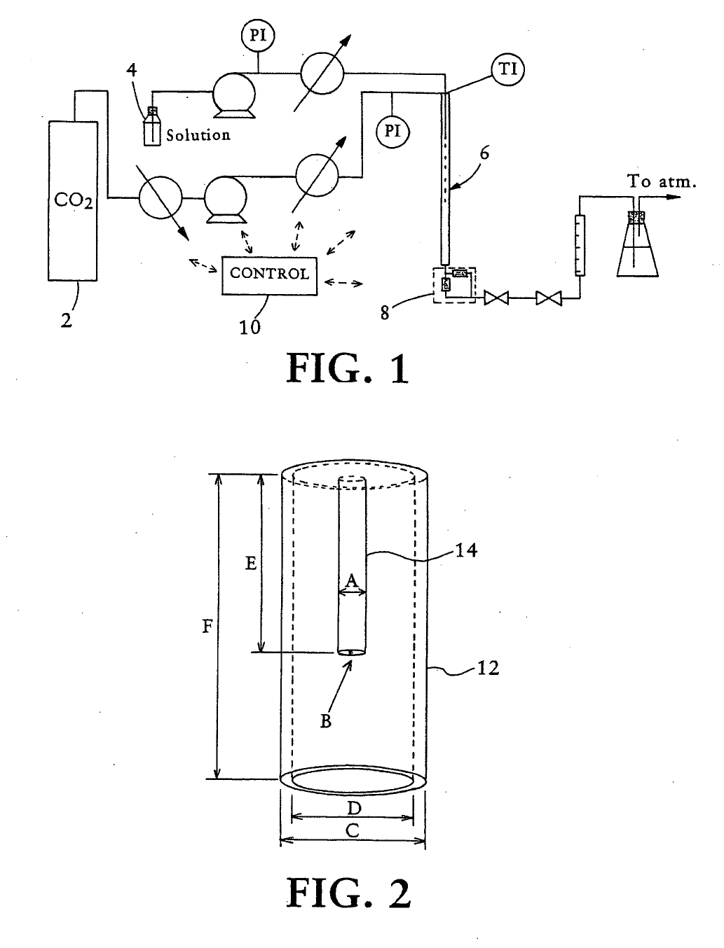

The apparatus shown on FIG. 1 conventionally comprises mainly a source 2 of supercritical fluid, a source 4 of a solvent containing a solute to be precipitated, a reactor vessel 6 and a container 8 for receiving the formed particles.

In the example shown, source 2 is carbon dioxide and container 8 is formed of two frit filters placed in parallel.

The supply lines between source 2 and reactor vessel 6 and between source 4 and reactor vessel 6 comprise conventionally valves, pumps, pressure detectors and temperature detectors. All these elements, as well as heating means for the reactor, backpressure regulating valves at the exit of the reactor vessel, and other conventional means (and thus not represented here) in such an apparatus are controlled and/or monitored by a control means 10 to maintain the supercritical antisolvent fluid in supercritical conditions during the process.

In accordance with one embodiment of the invention, the reactor vessel is formed of two coaxial tubes, as represented on FIG. 2, and can thus be termed a Concentric Tube AntiSolvent Reactor or CTAR. The first tube 12, or outer tube (hereinafter “the Tube”) is connected to the source 2 of supercritical antisolvent (SAS) fluid and the second tube 14, or inner tube (hereinafter “the Capillary”), is connected to the solution solvent/solute.

As a matter of examples, two reactors of the invention were designed and used in the experiments presented below. Their dimensions are listed in Table 1.

TABLE 1
flow sections and lengths of the reactor

| | | | | | | |
|---|---|---|---|---|---|---|
| | Capillary diameter | Tube | Capillary | | | Length of |
| Tube diameter (mm) | (mm) | section | section | Annular section | Length of Tube | Capillary (E) |

| | | | | | | | | |
|---|---|---|---|---|---|---|---|---|
| Inner (D) | Outer (C) | Inner (B) | Outer (A) | (mm²) | (mm²) | (mm2) | (F) (mm) | (mm) |

| | | | | | | | | |
|---|---|---|---|---|---|---|---|---|
| 3.85 | 6.35 | 0.15 | 1.59 | 11.6 | 1.98 | 9.7 | 545 | 120 |
| 8.50 | 12.70 | 0.15 | 1.59 | 56.7 | 1.98 | 54.8 | 620 | 120 |

Both the SAS fluid and the solution enter their respective tube at the top of them. Thus, as shown on FIG. 2, the Capillary exit is within the Tube such that the solution is contacted with the SAS fluid after this fluid had flown, allowing the SAS fluid flowrate to stabilize which limit the deposit of particles on the wall of the Tube.

### EXPERIMENTAL EXAMPLES

### Example 1

### L-Poly Lactic Acid (LPLA) Particles

An apparatus as represented on FIG. 1 was used, successively with the two CTARs of Table 1.

The material used was:
SAS fluid: CO₂ supplied by “Air Liquid” having a purity of 99.7%
solvent: methylene chloride from SDS
target material: LPLA from Galactic Laboratories.

For a typical run, a steady state flow of SAS CO₂ is performed with accurate pressure, temperature and flowrate. Then, the injection of the organic solution is performed during a fixed time. At the end of the experiment, a pure CO₂ flowrate is maintained during a few minutes in order to remove all the organic solvent and to dry the particles obtained. After complete depressurisation the powder is recovered from the tubes placed at the end of the external tube, on the frit filters.

Experimental results obtained with CTAR1 and CTAR2 are presented below in Table 2 and Table 3, respectively.

TABLE 2
Experimental results of the CTAR1 (smaller
external tube) (T = 308 K)

| | | CO₂ | | | | Solvent | Solvent | Molar ratio | Injection | Particle |
|---|---|---|---|---|---|---|---|---|---|---|
| | Pressure | density | LPLA | CO₂ flowrate | CO₂ speed | flowrate | speed | solvent/CO₂ | time | size |
| Run | (MPa) | (kg m−3) | (wt %) | (kg h−1) | (mm s−1) | (mL h−1) | (mm s−1) | (%) | (min) | (μm) |
| 1 | 8 | 488 | 1 | 0.466 | 27.5 | 48.0 | 754 | 7.1 | 9 | 1-3 |
| 2-11 | 10 | 705 | 1 | 0.373-0.565 | 15-23 | 24-60 | 377-943 | 3.5-8.9 | 12-75 | 1-2 |
| 12 | 10 | 705 | 2.0 | 466 | 19 | 48 | 754 | 7.1 | 40 | 1-2 |
| 13 | 10 | 705 | 3.0 | 466 | 19 | 48 | 754 | 7.1 | 38 | 0.5-2 |
| 14 | 10 | 705 | 5.0 | 466 | 19 | 36 | 754 | 5.3 | 30 | 0.5-1 |
| 15 | 10 | 705 | 5 | 0.466 | 19 | 48 | 754 | 7.1 | 60 | 1-3 |
| 16 | 12 | 739 | 1 | 0.466 | 18.1 | 48 | 754 | 7.1 | 50 | 1-2 |
| 17 | 12 | 772 | 1 | 0.466 | 17.4 | 48 | 754 | 7.1 | 30 | 1-2 |

TABLE 3
Experimental results of the CTAR2 (larger
external tube) (T = 308 K)

| | | CO₂ | | | | Solvent | Solvent | Molar ratio | Injection | Particle |
|---|---|---|---|---|---|---|---|---|---|---|
| | Pressure | density | LPLA | CO₂ flowrate | CO₂ speed | flowrate | speed | solvent/CO₂ | time | size |
| Run | (MPa) | (kg m−3) | (wt %) | (kg h−1) | (mm s−1) | (mL h−1) | (mm s−1) | (%) | (min) | (μm) |
| 18-20 | 10 | 705 | 1 | 0.466 | 3.4 | 48 | 754 | 7.1 | 15-30 | 1-2 |
| 21 | 10 | 705 | 5 | 0.466 | 3.4 | 48 | 754 | 7.1 | 30 | 1-3 |
| 22 | 12 | 739 | 1 | 0.466 | 3.2 | 48 | 754 | 7.1 | 30 | 1-2 |

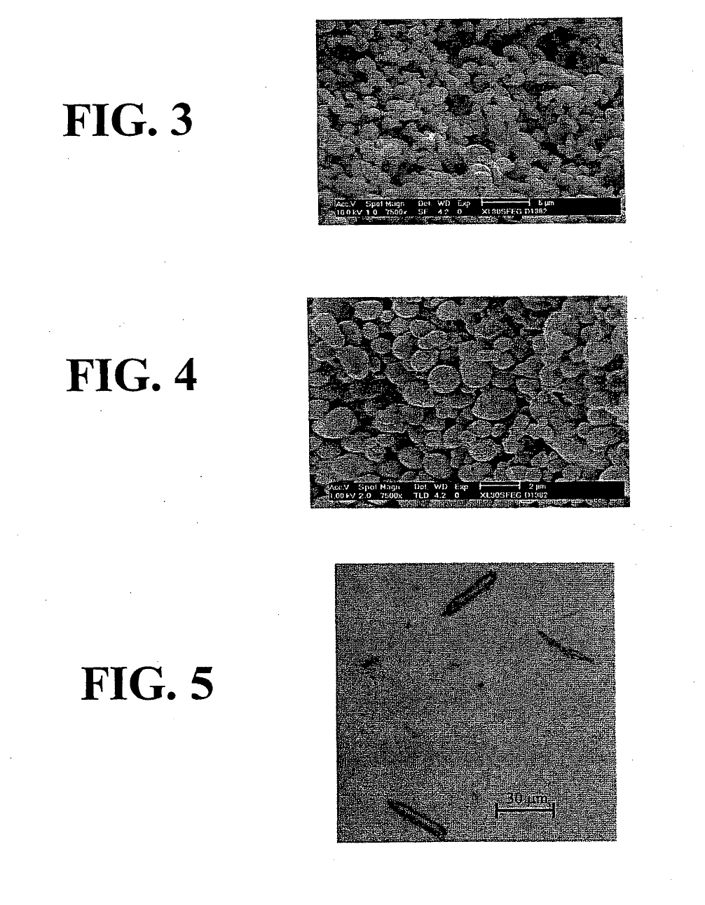

FIGS. 3 and 4 shows SEM photographies of particles obtained in run #8 and run #14, respectively.

In all the experiments particles with spherical aspects were obtained, showing the good running of the apparatus. It was noted that with CTAR1 a narrow particle size distribution has been obtained, with diameter ranging from 0.5 μm to 5 μm. For CTAR2, a less narrow particle size distribution was obtained, with diameter ranging from 1 to 20 μm.

The main difference between the two experiments is the size of the external tube leading, for a same flowrate, to an important difference of CO₂ flow speed. The ratio between the two cases is in the order of 6 (as can be deduced from the sections given in Table 1). It is to be noted that the CO₂ flow speed in a conventional reactor is in the order of 0.01 mm.s-1, which is about 300 times lower than in the experiments with the CTAR reactor.

Even if the range of variations of CO₂ flow rate is large, it remains laminar with a parabolic profile of the speed and no turbulence. However, a high flowrate of CO₂ must be maintained, even in our conditions, in order to keep a molar ratio of organic solvent/CO₂ low enough. However, in the conditions of the experiments, good results are obtained with molar ratio up to 8.9%, which is sensibly higher than in previous results found in literature (up to 5.2%).

Thus, a higher CO₂ flow speed and a higher concentration lead to the formation of a larger quantity of particles, in a given time period. For example, in runs #14 and #15 (Table 2) and run #21 (Table 3), the injection was stopped after a duration of roughly 30 mn because the powder recovery system at the exit of the reactor was full.

### Example 2

### Griseofulvin Particles

An apparatus as represented on FIG. 1 was used, with two different CTARs having different inner diameters. The inner diameter of the external tube is similar to those used in the first experiment above

Further, different solvents, different organic solvent/CO₂ concentration ratios and griseofulvin concentrations were tested. The results are shown in Table 4 below.

TABLE 4
Experimental results of the CTAR for the
micronisation of griseofulvin

| | | | Capillary | | Organic | Griseofulvin | |
|---|---|---|---|---|---|---|---|
| | Pressure | Temp. | internal | | solvent/CO₂ | concentration | |
| Run | (MPa) | (K) | diameter (μm) | Solvent | ratio (%) | (wt %) | Size (μm) |
| 1 | 10 | 308 | 500 | Acetone | 2.4 | 4 | 50.3 ± 18.5 |
| 2 | 10 | 308 | 500 | MC | 5 | 2 | 25.1 ± 12.3 |
| 3 | 10 | 308 | 500 | MC | 1.5 | 10 | 30.2 ± 8.2 |
| 4 | 10 | 308 | 500 | MC | 8 | 10 | 40.4 ± 13.4 |
| 5 | 10 | 308 | 500 | MC | 10 | 10 | 50.9 ± 17.4 |
| 6 | 10 | 313 | 128 | MC | 4 | 10 | 26.1 ± 7.9 |
| 7 | 10 | 318 | 128 | MC | 4.5 | 10 | 27.7 ± 9.0 |
| 8 | 10 | 323 | 128 | MC | 6.5 | 10 | 34.2 ± 11.0 |

MC: methylene chloride

Runs #3 and #5 were repeated several times in order to test the reproducibility of the process. Analysis by X-ray diffraction have shown that all crystals have the same polymorphique shape, which is the same as the one on the market. As shown on FIG. 5, which is a photography of the solid obtained in run #7, the particles have the form of a needle.

The needles have a size between 25 and 50 μm depending on the process conditions. This size is much smaller than the one of the needles obtained through conventional antisolvent process, which is in the order of a millimeter.

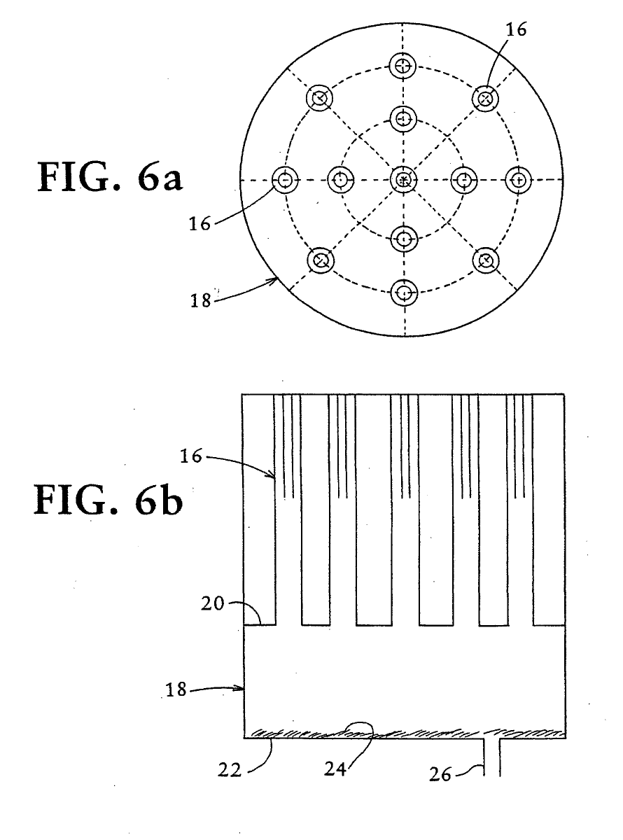

The apparatus of the invention may be easily scaled up for industrial production. An example of a reactor vessel for such apparatus is represented in top view and side view on FIGS. 6a and 6b, respectively.

The reactor vessel comprises a plurality of CTARs 16 similar to the CTAR shown on FIG. 2. It also comprises a single one container 18 the cover 20 of which forming a support plate for the CTARs.

Of course, the number of CTARs and their location are not limited. Also, the support plate may not be a disc but could have any other shape, i.e. a polygon, in particular square or a rectangle.

The bottom 22 of the container is provided with a filter 24, such as a frit filter, to retain the particles formed in the CTARs but to allow the fluids to exit the container through an exit canal 26.

What is claimed is :

1. An apparatus for forming particles of a target substance comprising :
a source of supercritical antisolvent fluid,
a source of a solvent containing a solute of a target substance to be precipitated, and
a reactor vessel having a first inlet end connected to the source of supercritical antisolvent fluid, a second inlet end connected to the source of solvent, and an outlet end,
a container connected to the outlet end of the reactor vessel for receiving the precipitated target substance, and
control means to operate the apparatus,
wherein said reactor vessel comprises a set of at least one tube pair, each tube pair comprising a first tube having a first end and a second end, and a second tube having a first end and a second end, the first and second tubes of each said tube pair being coaxial, the first inlet end of the reactor vessel being formed by the first end of all first tubes, the second inlet end of the reactor vessel being formed by the first end of all second tubes, the outlet end of the reactor vessel being formed by the second end of all first tubes, and the second end of each second tube being located closer to the first end of the corresponding second tube than to the second end of said corresponding first tube.

2. The apparatus of claim 1, wherein said tube pairs are dimensioned and said control means is operated such that the supercritical antisolvent fluid flows at a velocity of at least 1 mm/s within the first tube.

3. The apparatus of claim 1, wherein the container is provided with a filter to retain the formed particles.

4. The apparatus of claim 1, wherein the first tube of each tube pair has a length between 300 and 800 mm and an inner diameter between 2 and 20 mm.

5. The apparatus of claim 1, wherein the second tube of each tube pair has a length between 60 and 150 mm and an inner diameter between 50 and 500 μm.

6. The apparatus of claim 4, wherein the second end of the second tube of each tube pair is within the first tube at a distance of at least 100 mm from the first end of said first tube.

7. Reactor vessel for an apparatus for forming particles of a target substance, wherein said reactor vessel comprises:
a first tube having an inlet end intended, in operating conditions, to receive a supercritical antisolvent fluid and an outlet end intended, in operating conditions, to transmit particles formed within the reactor vessel, and
a second tube, coaxial with the first tube and having an inlet end intended, in operating conditions, to receive a solvent containing a solute of a target substance to be precipitated and an outlet end within the first tube for allowing contacting the supercritical antisolvent fluid with the solvent.

8. The reactor vessel of claim 7, wherein the first tube has a length between 300 and 800 mm and an inner diameter between 2 and 20 mm.

9. The reactor vessel of claim 7, wherein the second tube has a length between 60 and 150 mm and an inner diameter between 50 and 500 μm.

10. The reactor vessel of claim 8, wherein the other end of the second tube is within the first tube at a distance of at least 100 mm from the first inlet.

11. The reactor vessel of claim 7, wherein it comprises a plurality of first and second coaxial tubes, the second end of each first tube being mounted on one and the same support plate.

12. The reactor vessel of claim 11, wherein the support plate forms the cover of a container for retaining the particles.

13. The reactor vessel of claim 11, wherein the first tube has a length between 300 and 800 mm and an inner diameter between 2 and 20 mm.

14. The reactor vessel of claim 11, wherein the second tube has a length between 60 and 150 mm and an inner diameter between 50 and 500 μm.

15. The reactor vessel of claim 13, wherein the other end of the second tube is within the first tube at a distance of at least 100 mm from the first inlet.

16. A method for forming particles of a target substance comprising (a) providing in a predetermined direction a flow of a supercritical antisolvent fluid, (b) providing in the same direction a flow of a solvent containing a solute of the target substance to be precipitated, wherein the two flows are coaxial and the supercritical antisolvent fluid has a velocity of at least 1 mm/s.
